(19) United States
(12) Patent Application Publication
(10) Pub. No.: US 2019/0001372 A1
(43) Pub. Date: Jan. 3, 2019

(54) Coating for Lining a Compressor Case

(71) Applicant: Standard Aero Limited, Winnipeg (CA)

(72) Inventors: Graeme Edward CRAWFORD, Winnipeg (CA); Chad Christian KAATZ, Winnipeg (CA); Douglas Michael ROBERGE, Winnipeg (CA); Wayne Wilfred THOMAS, Winnipeg (CA); Izabela WITKOWSKA, Winnipeg (CA)

(21) Appl. No.: 16/113,696

(22) Filed: Aug. 27, 2018

Related U.S. Application Data
(63) Continuation of application No. PCT/CA2017/050244, filed on Feb. 24, 2018.
(60) Provisional application No. 62/300,649, filed on Feb. 26, 2016.

(51) Int. Cl. B05D 7/14; F04D 29/60; F04D 29/40; F01D 11/12; F01D 25/00; B05D 3/12; B05D 7/22; B05D 7/00

(52) U.S. Cl. CPC B05D 7/146; F04D 29/601; F04D 29/403; F01D 11/122; F01D 25/005; F05D 2300/44; B05D 7/222; B05D 7/544; F05D 2220/32; F05D 2230/90; F05D 2300/611; B05D 3/12

(57) ABSTRACT

A lining for a compressor case is provided. The lining comprises a layer of primer applied to an interior surface of the compressor case, and at least one layer of a seal compound applied to the layer of primer. The primer has been found to significantly improve the bond strength between the base metal and the coating. Also, the primer provides a waterproof coating at the bond interface, which prevents any moisture from creeping under the plastic and causing material break-out. The waterproof coating also provides an increased corrosion resistance to the base metal and stator vanes where the plastic lining has been applied. A method of lining a compressor case is also provided, comprising applying a first layer comprising a primer to an interior surface of the compressor case, and applying at least one second layer over the first layer of primer, the at least one second layer comprising a seal compound to line the compressor case.

### CROSS REFERENCE TO RELATED APPLICATION(S)

This application is a continuation of PCT Application No. PCT/CA2017/050244 filed on Feb. 24, 2017, which claims priority to U.S. Provisional Patent Application No. 62/300,649 filed on Feb. 26, 2016, both incorporated herein by reference.

### TECHNICAL FIELD

The following relates to coatings for lining a compressor case, particularly for repairing such compressor cases, and relates to a method for applying same.

### DESCRIPTION OF THE RELATED ART

Gas turbine engines typically include an air compressor fluidly coupled to a turbine with a combustion chamber disposed between the compressor and the turbine. Compressors generally include a compressor wheel with a number of spaced-apart blades on the wheel and corresponding stationary vanes. The compressor wheel is rotated about an axis within the engine housing to receive air from an inlet, accelerate and compress that air, and then discharge the air through an outlet. The air is generally forced to flow between the space defined by the blades, the rotational hub of the compressor wheel, and a portion of the engine housing commonly referred to as a compressor case. The compressor case also includes blades or vanes in staggered orientation to the wheel vanes to further compress the air.

To increase compressor efficiency, a minimal running clearance is typically maintained between the interior wall of the compressor case and the tips of the wheel blades or vanes, to prevent leakage of the air. However, during normal operation of the compressor, centrifugal forces acting on the compressor wheel cause it to enlarge radially towards the case. Because of this, establishing minimum running clearances at operational speeds of the compressor can be difficult to determine. Moreover, errors in these clearances can cause efficiency losses and/or failures of the compressor and engine.

To address these concerns, a lining or coating has traditionally been included within compressor cases. The coating is a thin layer, usually a thermosetting plastic or thermal sprayed coating (i.e. spraying molten metal/polymer mixtures onto the interior of the compressor case), that minimizes clearance between the coating and the tips of the wheel vanes. Additionally, the coating or lining is made to be abradable, which allows the vanes to extend into the coating if they expand due to the centrifugal forces, or other reasons.

However, the base metal of the compressor case, and the resin coating have different coefficients of thermal expansion. As such, during operation, thermal cycling can cause the case plastic to crack/break-out. Cracks in the case plastic allows water/moisture to penetrate the plastic coating, which leads to corrosion of the stator vanes and separation of the plastic from the base metal.

As such, the plastic lining or coating is normally inspected periodically for such cracks. If the cracks are found to be beyond acceptable limits, the cracked lining is removed and the compressor case repaired and a new lining added. The cost of performing these inspections and repairing the compressor case by adding new linings is typically considered to be expensive, and it is generally undesirable to have to perform these repairs numerous times over the life of the compressor.

### SUMMARY

In one aspect, there is provided a method of lining a compressor case, the method comprising: applying a first layer comprising a primer to an interior surface of the compressor case; and applying at least one second layer over the first layer of primer, the at least one second layer comprising a seal compound to line the compressor case.

In another aspect, there is provided a lining for a compressor case, the lining comprising: a layer of primer applied to an interior surface of the compressor case; and at least one layer of a seal compound applied to the layer of primer.

The primer can be a silane, epoxy or water-based primer capable of providing any one or more of an improved bond strength between the base metal of the compressor case and the seal compound, a waterproof coating at the bond interface to inhibit moisture from creeping under the plastic, and an increased corrosion resistance to the base metal and stator vanes where the seal compound has been applied.

The seal compound can be a resin-based formulation, and the resin-based formulation can comprise a resin, a talc filler, a resin curing agent, a graphite filler, a silicone dioxide filler, and a catalyst.

### BRIEF DESCRIPTION OF THE DRAWINGS

Embodiments will now be described by way of example only with reference to the appended drawings wherein:

FIG. 1 is an exploded view of a compressor used with a gas turbine engine;

FIG. 2 is a perspective view of a compressor casing according;

FIG. 3 is an end view of the compressor casing shown in FIG. 2;

FIG. 4 is a side view of one half of a compressor casing before a lining has been applied;

FIG. 5 is a side view of one half of a compressor casing after the lining has been applied;

FIG. 6 is an enlarged cross-sectional view of the lining applied to the compressor casing;

FIG. 7 is a flow chart illustrating a process for applying the lining to the compressor casing;

FIG. 8 illustrates cracking of a compressor case plastic on an unprimed case;

FIG. 9 illustrates reduced cracking of a compressor case plastic on a primed case;

FIG. 10 is a chart illustrating lap shear test results;

FIG. 11 illustrates primed airfoils after a 7 day salt fog exposure;

FIG. 12 illustrates unprimed airfoils after a 7 day salt fog exposure;

FIG. 13 illustrates a comparison of a primed case half (left) and an unprimed case half (right) after a salt spray;

FIG. 14 illustrates a primed case half after a 7 day salt fog;

FIG. 15 illustrates primed case half airfoils after a 7 day salt fog;

FIG. 16 illustrates an unprimed case half after a 7 day salt fog;

FIG. 17 illustrates unprimed case half airfoils after a 7 day salt fog;

FIG. 18 illustrates a series of prepared wedge crack test specimens;

FIG. 19 illustrates wedge crack test specimens immersed in a test environment;

FIG. 20 illustrates unprimed wedge crack extension test results; and

FIG. 21 illustrates primed wedge crack extension test results.

### DETAILED DESCRIPTION

To address the aforementioned problems with compressor case lining cracks, etc.; a primer such as a silane (SiH₄)-based, epoxy, or water-based primer can be added to the interior of the compressor case prior to the application of the seal compound, typically an epoxy resin mixture. For example, a silane primer has been found to significantly improve the bond strength between the base metal and the epoxy coating. Also, the silane primer provides a waterproof coating at the bond interface, which prevents any moisture from creeping under the plastic and causing material break-out. The waterproof coating also provides an increased corrosion resistance to the base metal and stator vanes where the epoxy has been applied. It can be appreciated that other primers can be used that achieve one or more of these advantages and results. For the purpose of illustration, the following may refer to a silane-based primer, but it will be appreciated that these principles can equally apply to similar primers.

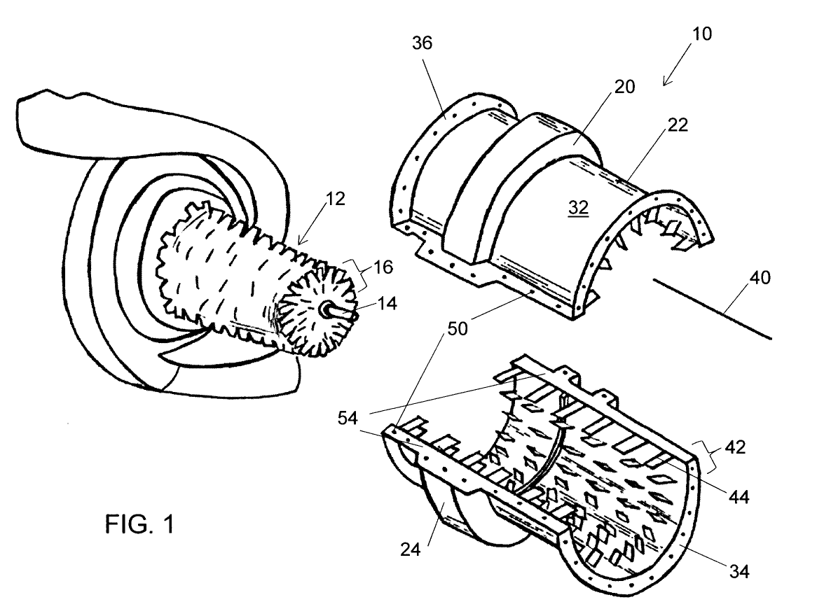

Turning now to the figures, FIG. 1 illustrates an exploded view of a compressor 10 section of a gas turbine engine (not shown). The compressor 10 shown in FIG. 1 includes a compressor casing 20. Extending into the compressor casing 20 is a rotor structure 12. The rotor structure 12 includes a rotating shaft 14 that extends through the engine to a turbine (not shown). The rotating shaft 14 includes multiple rotor vane bands 16 spaced along the length of the rotating shaft 14, each having a series or set of wheel blades 18 extending away from the rotating shaft 14. The compressor casing 20 can include any appropriate shape (e.g., annular shape) having interior and exterior surfaces 30, 32, inlet and outlet ends 34, 36, and a central axis 40 running through the center of the compressor casing 20. However, the figures show the compressor case 20 to be generally a cylinder shape. As shown, the compressor casing 20 may be divided into first and second halves 22, 24. A plurality of vane bands 42 are disposed on the inside surface 30, each of which include a plurality of vanes or blades 44.

The first and second halves 22, 24 of the compressor casing 20 are connected to one another at connecting holes 50 and may be connected by bolts, pins, or other securing or fastening mechanisms. In this way, the casing 20 surrounds the shaft 14 and wheel blades 18 extending outwardly from the shaft 14. It should be noted that the longitudinal axis 40 of the compressor casing 20 is in line with the longitudinal axis (not shown) of the shaft 14. In the implementation shown in FIG. 1, the wheel blades 18 and the vanes 44 in the compressor casing 20 are alternated or staggered such that the wheel blades 18 are rotatable in the spaces between the vane bands 42 of vanes 44. The angles and lengths of the various wheel blades 18 and compressor case vanes 44 can vary, however, it can be appreciated that these angles and lengths are typically set by industry standards.

When the wheel blades 18 move relative to the vanes 44, air advances from the inlet end 34 of the compressor casing 20 through the multiple rows of compressor and wheel blades 18, 44, and discharges through the compressor outlet end 36, with advancing air being compressed.

For the sake of efficiency, the wheel blades 18 should extend from the rotor shaft 14 such that little to no air is permitted to pass between the end of the rotor wheel blade 18 (the tip) and the interior wall 30 of the compressor casing 20. As noted above, since the compressor casing 20 and the wheel blades 18 may both be composed at least in part of a metal, such as steel, the wheel blades 18 may expand due to centrifugal force and heat. The extended or expanded wheel blades 18 may then come in contact with the interior wall 30 of the compressor casing 20. Therefore, a lining 56 is applied to the interior wall 30 of the casing 20. The lining 56 should be applied after the vane bands 18 have been attached to the interior wall 30 of the casing 20.

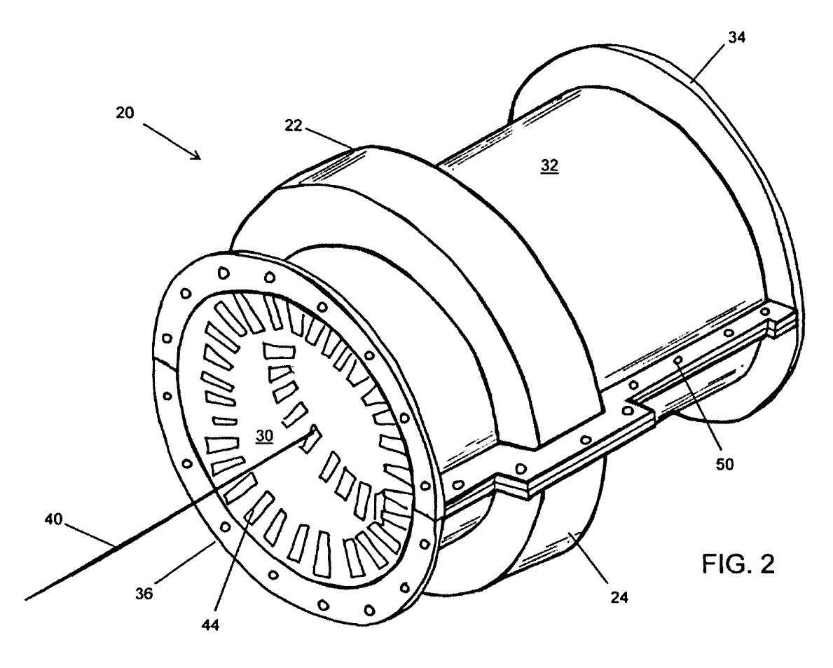

FIG. 2 is a perspective view of the compressor casing 20. It can be seen that the compressor casing 20 can be formed of two halves 22, 24, and the two halves are typically made to be mirrored images of one another, and are attached to each other. The halves 22, 24 may be attached using the holes 50. However, the halves 22, 24 may also be attached to one another by other fastening mechanisms, such as by adhesive, rivets, welding, or any other way known in the art. Also shown in FIG. 2 is the lining 56, which is a thin layer applied about the circumferential interior surface 30 of the compressor casing 20. Additionally, the plurality of vanes 44 are shown to extend through the lining 56 and towards the longitudinal axis 50 of the casing 20.

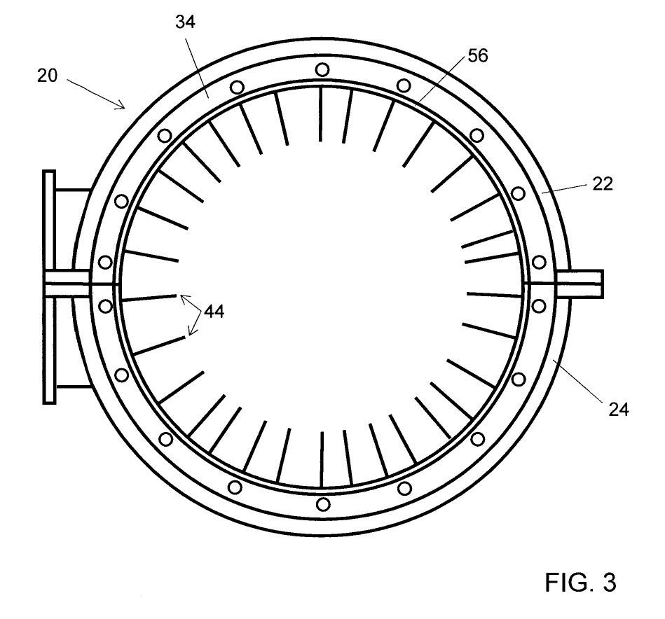

FIG. 3 is an end view of the compressor casing 20 illustrated in FIG. 2. FIG. 3 illustrates that the vanes 44 are radially spaced around the interior surface 30 of the casing 20. FIG. 3 also shows that the lining 56 should be evenly distributed about the casing 20.

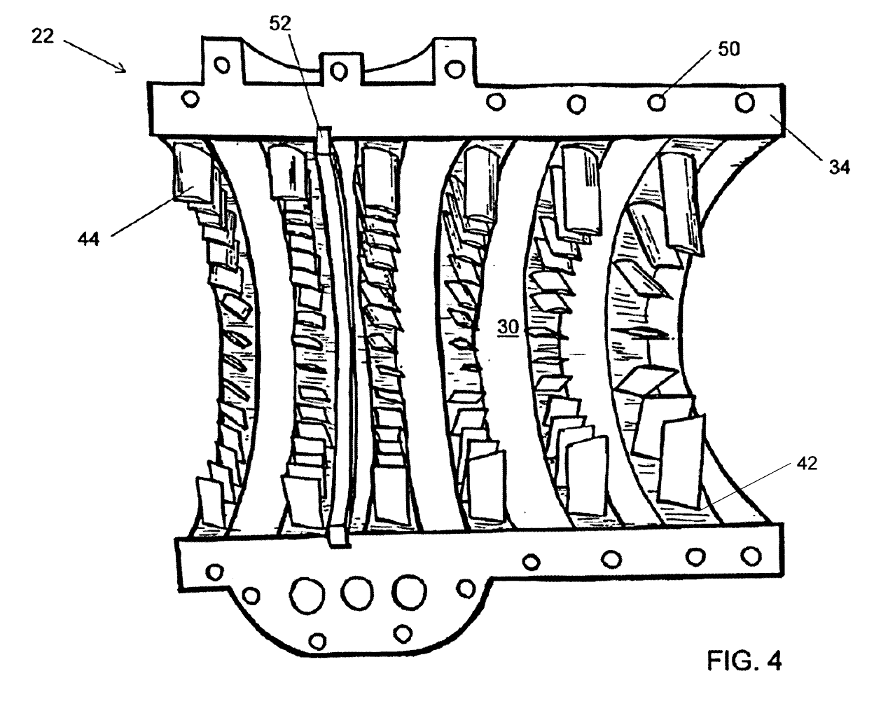

FIG. 4 is a side view of one half 22 of the compressor casing 20 before the lining 56 has been applied to the interior 30 of the casing 20. As can be seen in FIG. 4, the plurality of vanes 44 are attached to vane bands 42. The vane bands 42 comprise a rigid material, such as steel or a composite material. The vanes 44 are also a rigid material such as steel, titanium, or composite material, and can be affixed to the vane bands 42 by welding, brazing, adhesives, or other attaching mechanisms. The location of the bands 42 at the interior surface 30 of the compressor casing 20 is determined by industry and/or government standards. Therefore, the number of bands 42 and vanes 44 may vary according to the standards, and that the principles described herein should not to be limited to the exact location and number of bands shown in FIG. 4.

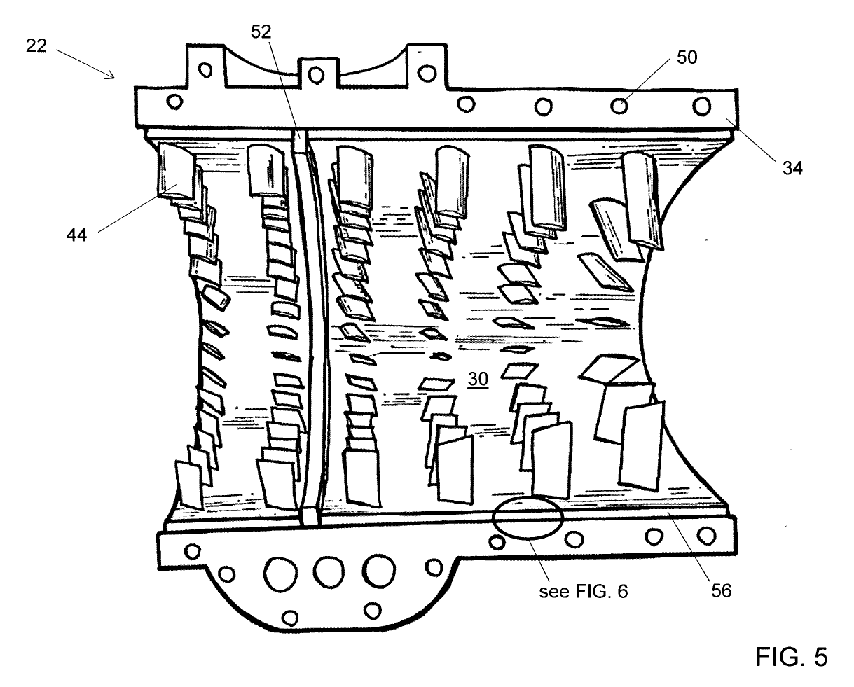

FIG. 5 is a side view of one half 22 of the compressor casing 20 after the lining 56 has been applied. As shown in FIG. 5, the lining 56 forms a smooth coating on the interior wall 30 of the casing 20. The thickness of the lining 56 is such that the amount of space between the edge of the wheel blade 18 and the lining 56 is minimal, or even negligible to provide the greatest efficiency in compressing the air in the compressor. The lining 56 should also be abradable such that if the wheel blades 18 expand and extend while spinning, the lining 56 allows the vane to rub and wear into the lining 56 without damaging either the compressor casing 20 or the wheel blades 18. In addition, the lining 56 is formulated from a mixture capable of undergoing the temperature cycles experienced by the engine. For instance, in some circumstances the engine undergoes temperature cycles from ambient temperatures up to 400° F., many times. Therefore, the lining 56 should be capable of withstanding the temperature cycles and having a life to withstand multiple temperature cycles without cracking or otherwise becoming damaged.

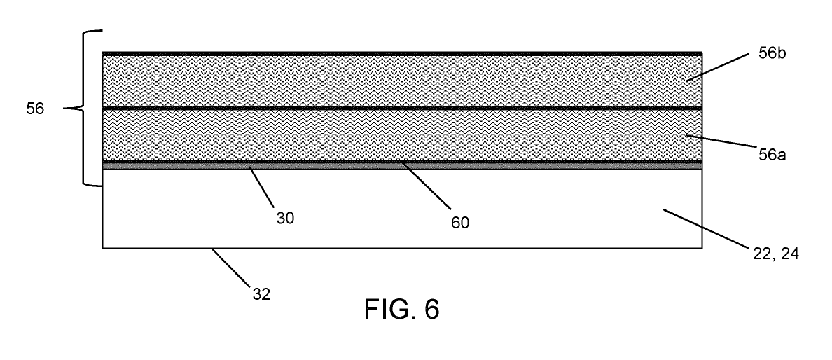

As illustrated in FIG. 6, the lining 56 can be applied in multiple layers (56a and 56b). Moreover, as discussed above, in order to improve the bond strength between the base metal (30) and the thermosetting polymer (e.g. epoxy) coating (i.e. the lining 56), to provide a waterproof coating at the bond interface, and to provide an increased corrosion resistance to the base metal and stator vanes where the thermosetting polymer has been applied; a primer coating or layer 60 is applied to the interior wall 30 of the case 20, prior to applying the lining 56. As noted above, this layer 60 can be silane-based, epoxy-based, water-based, etc. This layer 60 or coating can be applied thinly, e.g., 0.0001″-0.0003″.

A suitable resin-based seal compound to form the lining 56 can be one that is formulated from a mixture of resin (e.g. epoxy resin), talc filler, a curing agent for the resin, a graphite filler, a silicon dioxide filler, and a catalyst such as a diethylaminoethanol catalyst. The following Table 1 provides an example breakdown of these parts by weight.

TABLE 1
Lining Materials - Parts by Weight

| | Parts by |
|---|---|
| Material | Weight |
| Resin | 200 |
| Talc Filler | 155 |
| Epoxy Resin Curing Agent | 76 |
| Graphite Filler | 30 |
| Silicone Dioxide Filler | 5 |
| Catalyst | 2.5 |

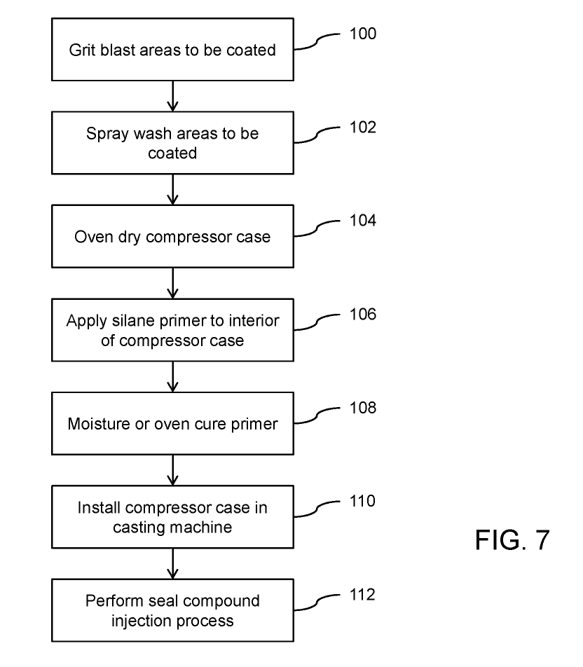

Such a lining 56 is applied after having applied the primer layer 60 to the interior wall 30 of the case. An example of a process for applying the primer layer 60 and the lining 56 thereafter is illustrated in FIG. 7, wherein steps 100-108 correspond to steps performed in applying the primer layer 60 and steps 110 and 112 illustrate the general stages used to apply the above-described lining 60, further details of which are provided below.

At step 100, the areas of the case 20 to be coated, i.e. the interior surface 30 of the case 20 are grit blasted, and incidentally the vanes 44. The areas to be coated are then spray washed in step 102, e.g., using an organic solvent such as acetone, isopropyl alcohol, etc., to remove oils and grease from the surfaces being coated. The compressor case is then oven dried at step 104, e.g., for 15-30 minutes. The oven drying is performed to remove any surface moisture from the surfaces that may have accumulated as the organic solvent dries. At step 106, the layer 60 of primer is applied to the interior surface 30 of the compressor case 20, e.g., to a thickness of 0.0001″-0.0003″ using a brush, spray or dip application method. Next, the primer layer 60 is cured, for example, by moisture curing the primer in air at, e.g., 70-90° F. and a relative humidity (RH) of 50-80% for 1-2 hours; or oven curing the primer at 190° F. for 3-5 minutes. It should be noted that the air being drawn into the oven should be approximately 50-80% RH.

After the primer layer 60 has been cured at step 108, the application of the lining 56 is performed by installing the compressor case in a casting machine at step 110, and performing a seal compound injection process at step 112.

The installation process at step 110 can be performed as follows:

A. When necessary, seal the compressor case bleed manifold 52 with a neoprene shim, a silicone rubber compound (a room temperature vulcanizing silicone rubber compound), or an equivalent.

B. Apply a thin coat of approved mold release to both sides of the horizontal splitline shims. Such shims are placed along the splitlines 54—see FIG. 1 of the case 20 to allow the case to be separated after the lining 56 has been applied.

C. Place a steel shim stock between the horizontal splitlines and install bolts and torque to specified requirements.

D. Install locating rings on the compressor case 20, and join the assembly to the casting machine (not shown).

The seal compound injection process at step 112 can be performed as follows:

I. Begin rotating the compressor case 20 and maintain a consistent RPM, e.g., 500 RPM. Also, heat the compressor case 20 to approximately 190-210° F. (88-99° C.); and heat the injection fixturing to approximately 180-200° F. (82-93° C.).

II. Inject a desired (or required) quantity of thermosetting plastic compound (e.g., according to the formulation mentioned above) to create a first layer 56a over the primer layer 60 as shown in FIG. 6.

III. After a period of time, e.g., 2 minutes, increase the rotational speed of the case to approximately 2000-2050 RPM while maintaining the temperature of the compressor case 20 at approximately 190-210° F. (88-99° C.). The rotational speed of 2000-2050 RPM is maintained for an additional period of time, e.g., 2-3 minutes.

IV. Reduce the rotational speed of the compressor case 20 to about 500 RPM. The 500 RPM rotational speed is maintained while injecting an additional quantity of the thermosetting plastic compound (e.g., according to the formulation mentioned above) to create a second layer 56b over the first lining layer 56b as shown in FIG. 6.

It can be appreciated that while the application of two lining layers 56a, 56b is demonstrated herein, the principles and benefits associated with the primer layer 60 being applied to the interior surface 30 of the compressor case 20 equally apply to a lining 56 comprising a single layer, or more than two layers.

Several tests (summarized below) were performed to evaluate the performance of a silane-based primer when applied as layer 60 prior to application of an abradable seal compound as the lining 56. The tests performed included thermal cycling, lap shear, salt spray and harmonic frequency testing. The silane-based primer was found to improve the adhesion properties between the base material and an epoxy resin, which results in high bond strength, greater corrosion resistance, and better thermal cycling resistance. Wedge crack extension test results have shown that failure mode of the coating system can improve to a point of up to 100% cohesive failure. The harmonic frequency tests have snow that the addition of a primer to the stator vanes should have a negligible effect on the natural frequency of the airfoils.

### Thermal Cycling Testing

Two compressor cases were tested to OEM requirements for thermal cycling. One compressor case was prepared and had case plastic applied following a standard overhaul process. The other case underwent the same process with the addition of the application of a silane-based primer to the inner diameter of the compressor case surfaces (including stator vanes) prior to applying the abradable plastic. Both compressor cases were subcontracted for thermal cycle testing in accordance with the OEM requirements.

These requirements state that one case assembly, selected at random from production operations according to a quality sampling plan, is to be subjected to 5 thermal cycles, with each cycle consisting of heating to 350° F.±10 (175° C.±5) for 45 minutes±5 and sub-zero cooling to −65° F.±10 (−55° C.±5) for 15 minutes±2. According to these requirements, evidence of linear cracking or lack of bonding at the splitline or rear of case should be cause for rejection of the part, and evidence of axial separation at the forward plastic dam is acceptable, providing no radial bond separation at the splitlines is evident.

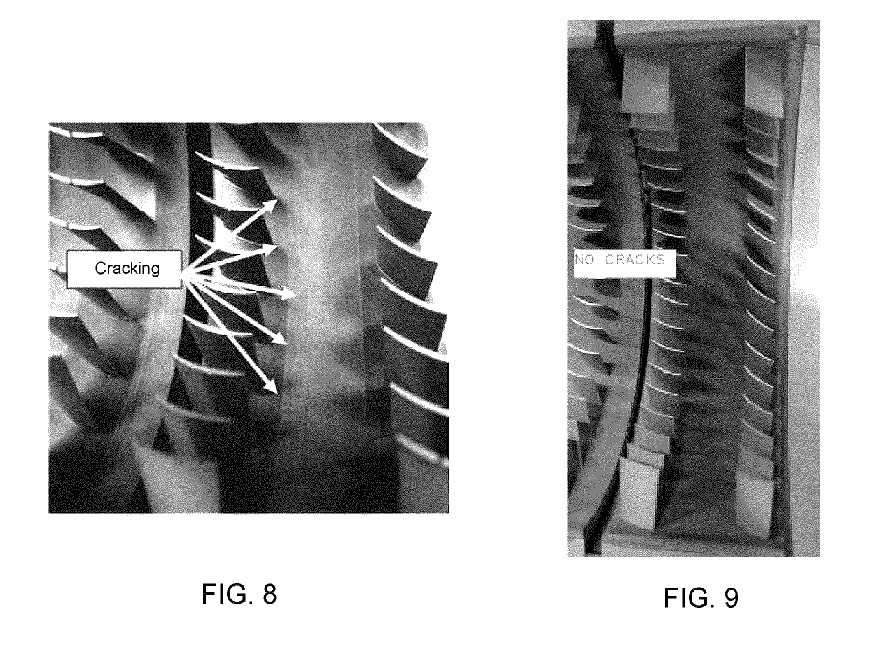

After thermal cycle testing, both compressor cases passed the inspection criteria for the thermal cycle test specified in the above-noted requirements. On the unprimed case, axial cracking of the plastic between stator vanes was noted, particularly between the trailing edge of 5th stage stators and the leading edge area of 6th stage vanes as shown in FIG. 8.

As seen in FIG. 8, the case plastic exhibited numerous axial cracks between the 5th and 6th stage stator vanes. The cracks propagate from the trailing edge of the 5th stage vane towards the leading edge of the 6th stage vanes. Cracking in this region is a common occurrence on overhauled cases due to the higher operating temperatures and pressures experienced in service.

On the primed case, axial cracking was also observed, but with the total number of cracks significantly reduced as shown in FIG. 9. The case plastic also did not exhibit any cracking between the 5th and 6th stage vanes. Plastic cracks on the primed case tended to be between adjacent stator vanes rather than originating from stator vane trailing edges.

### Lap Shear Testing

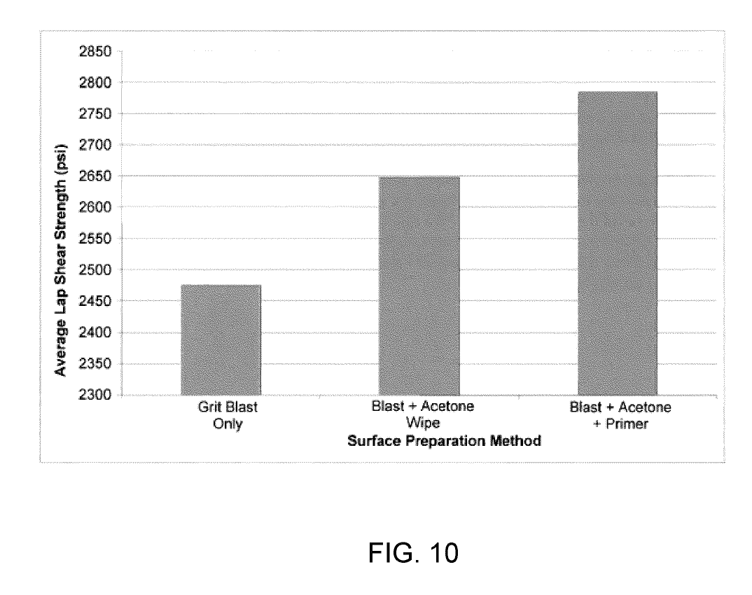

Compressor case plastic adhesion was evaluated by performing lap shear testing per OEM specifications. A total of eight lap shear coupons were prepared to investigate the effect of surface preparation and the use of adhesion promoting primer on the lap shear strength of the case plastic bond. Two coupons had plastic applied following grit blasting which is representative of the current overhaul process, three coupons were prepared with the addition of an acetone wipe after grit blast, and three coupons were prepared with the addition of an acetone wipe and the adhesion promoting primer prior to application of case plastic. Results of the lap shear tests are shown in FIG. 10.

The average lap shear strength utilizing the grit blast preparation was 2475 psi as compared to 2647 psi with the acetone wipe and 2784 psi with the adhesion promoting primer. All coupons met the minimum average lap shear strength of 2300 psi, required by the OEM. By employing the adhesion promoting primer and acetone wipe prior to the application of the case plastic as part of the compressor case overhaul process, the lap shear strength of the plastic bond was increased by 12.5%.

### Environmental/Corrosion Testing

Three separate environmental/corrosion tests were performed on representative samples in order to evaluate the environmental effects of the addition of a primer to the coating system.

Salt Spray Testing of Coupons

A salt spray testing comparison between primed compressor case stator vanes and un-primed vanes was performed. The airfoils were exposed to a salt fog environment in order to ensure that the primer would not have an adverse effect on the base material when exposed to a corrosive environment.

The test coupons were subjected to a salt fog environment for a duration of 7 days. Upon completion of the salt spray testing, the test samples were visually inspected for comparison of the corrosion products formed during testing.

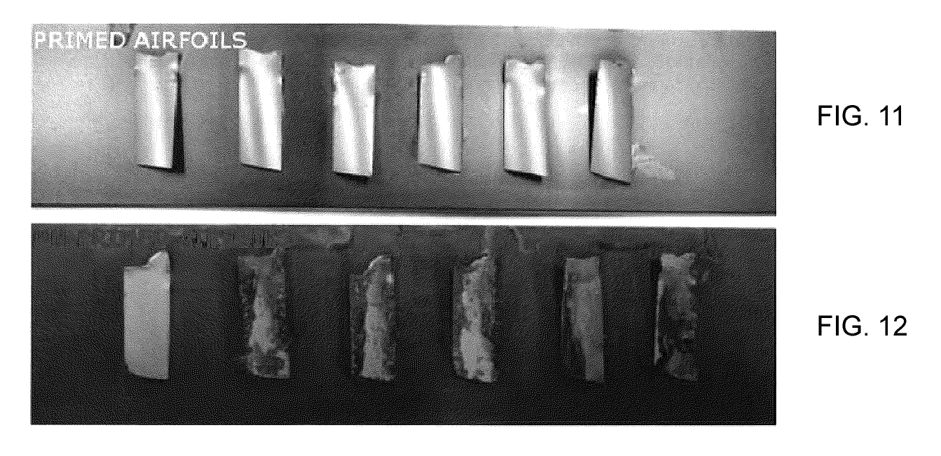

As shown in FIGS. 11 and 12, the un-primed airfoils (FIG. 12) exhibited severe corrosion after being exposed to the salt fog in comparison to the airfoils that had been coated with the primer (FIG. 11).

Therefore, the addition of a silane based primer to the inside of the compressor case should not have an adverse effect on the airfoils when exposed to a corrosive environment.

Salt Spray Testing of Compressor Case Assembly

A complete compressor case and vane assembly was also subjected to salt fog environment to evaluate the effects of the addition of the primer on the case plastic and stator vanes under adverse environmental conditions. One half of the compressor case assembly was prepared and coated with the epoxy resin coating per OEM documentation. Primer was sprayed on the inside of the other half of the same compressor case (including stator vanes) prior to the application of the case plastic. Both case halves were then subjected to a salt fog environment for a seven day duration. Exposed steel surfaces of the compressor case not covered by the case plastic were painted with Deft grey paint in order to provide corrosion protection so that any corrosion products from these surfaces would not influence test results.

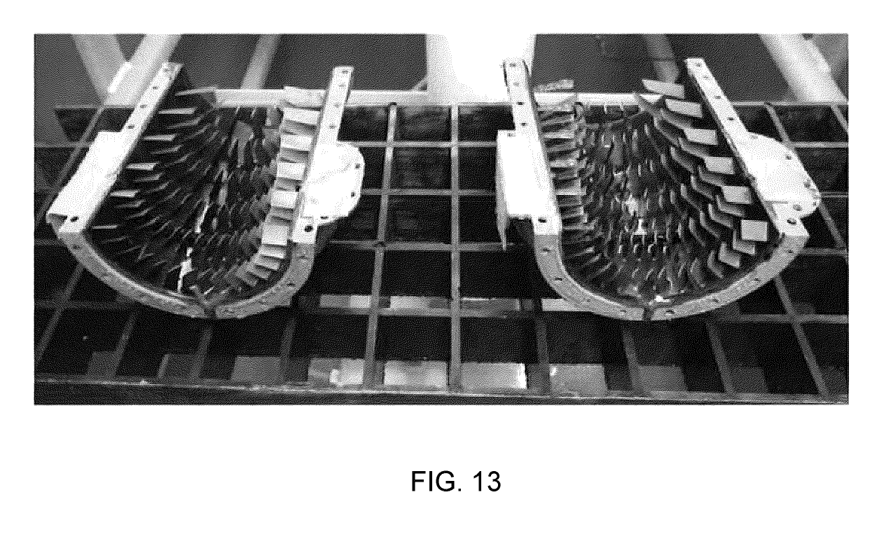

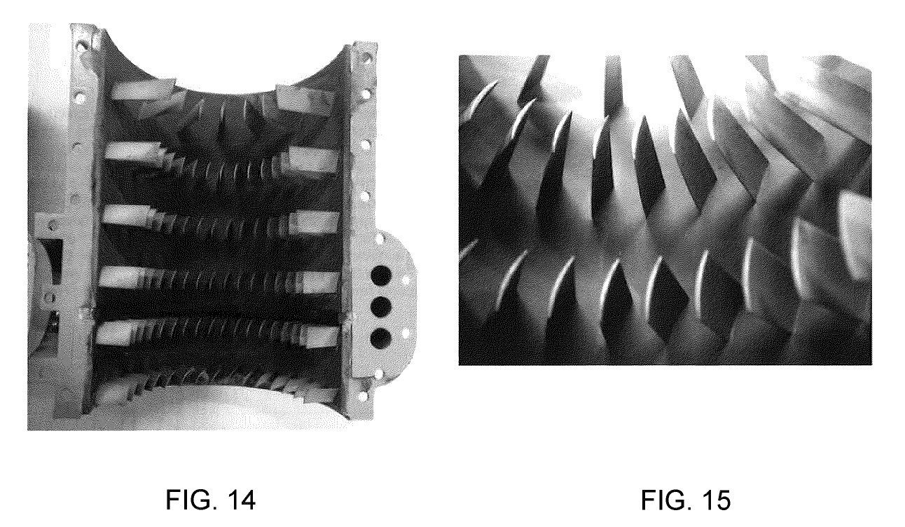

After 72 hours of salt fog testing, corrosion products had begun to form on both compressor cases except significantly more corrosion had already formed on the un-primed compressor case half as shown in FIG. 13. Both compressor case halves were visually inspected after being exposed to the salt fog environment for 7 days. As shown in FIGS. 14 and 15, the primed compressor case showed very minor corrosion products from three of the sixth stage stator vanes. The airfoils on this compressor case half also show minor signs of corrosion.

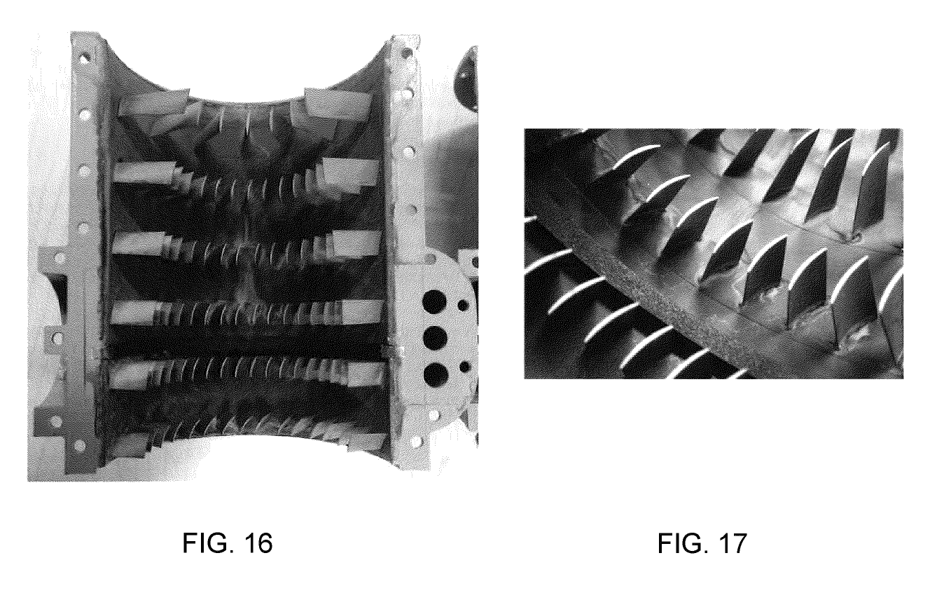

The un-primed compressor case showed significantly more corrosion products formed at the root of the airfoils after being exposed for 7 days (FIGS. 16 and 17). Root corrosion on stator vanes is known to be a contributing factor in the cause of stator vane failures. Additionally, compressor case overhaul experience has shown that root corrosion is the leading cause for rejection of stator vane bands at overhaul. Much of the corrosion observed on service exposed stator vane roots is below the plastic inner diameter suggesting that crevice corrosion is a primary mechanism in stator vane degradation in this area. By employing the primer in this location, crevice corrosion can be reduced by improving the bond between the case plastic and the stator vane and providing environmental protection to the stator vane parent material.

Wedge Crack Extension Testing

The third environmental test that was performed on the compressor case coating system was wedge crack extension testing. This test method provides a qualitative comparison of adhesively bonded joints. This test method also provides an indication of the environmental resistance of adhesively bonded joints. Testing requirements state that this method [wedge crack] has proven to be correlatable with service performance in a manner that is much more reliable than conventional lap shear tests.

Qualitative testing was performed on the existing compressor case coating as well as the compressor case coating with the addition of the primer on the base metal. Two 6″×6″×0.125″ AMS 5512 (347 Stainless) test coupons were prepared for each coating system. A separator film (Flashbreaker tape) was applied to three sides of the test coupons to a thickness of 0.005″ in order to create a uniform bond thickness of 0.005″ between the test coupons. Both sets of test coupons were grit blasted and washed with acetone prior to the application of the epoxy resin. One set of coupons had the addition of the primer prior to the application of plastic. Both sets of coupons were then pre-heated to 200° F. in order to simulate a compressor case being heated in the oven on the pouring machine.

After reaching 200° F., the case plastic was poured onto the surface of one coupon in each set. Each set of coupons were then assembled together with the prepared surfaces facing each other. Then, both sets of coupons were placed into the oven, baked at 200° F. for 2 hours and then cured at 250° F. for 13 hours. The additional bake was performed in order to simulate the compressor case casting process where the case rotates on the pouring machine at 200° F. for 2 hours prior to the final oven cure.

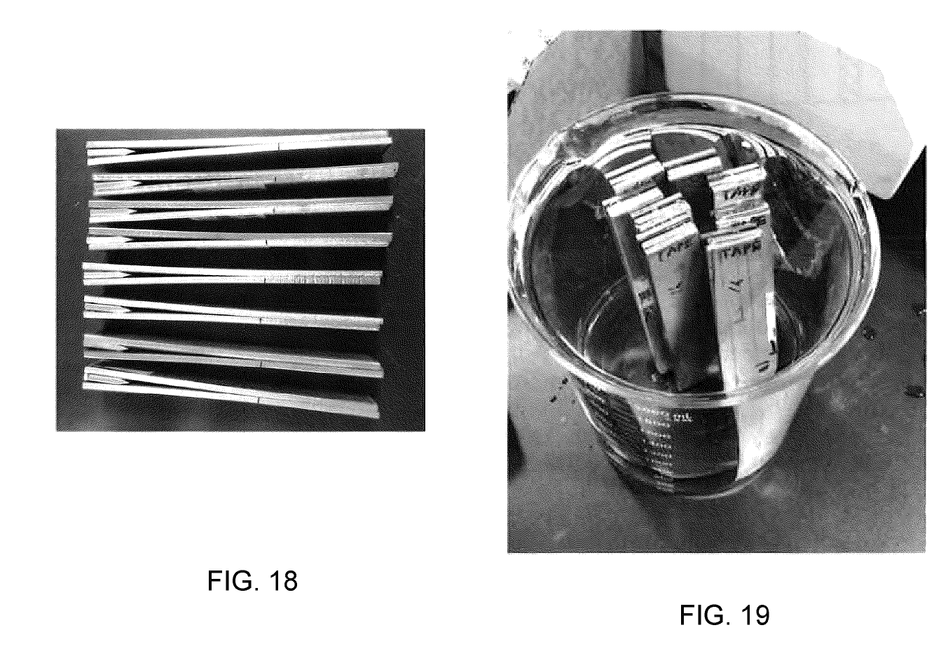

Once cured, the original test panels were milled into 1″ wide test coupons, which resulted in 5 test coupons for each coating system. Stainless steel wedges were then manufactured. After manufacture of the test coupons was completed, wedges were driven completely into each of the test coupons (at the taped edge) to apply a uniform tensile load across the coated surfaces (See FIG. 18). A 0.75″ strip of separator film at one end of each test coupons provides an unbonded region that allows the wedges to be inserted between the two test panels. The tensile load on the adhesively bonded joint causes an initial crack to form along the centerline of the joint. Under 5 to 30× magnification, the tip of the crack, aₒ, was identified on all of the samples (FIG. 18).

Once the initial crack tip locations are identified, the test samples are immersed into a prescribed test environment in order to evaluate the environmental resistance of the coatings, OEM documentation provides multiple standard test environments that may be used to assess the environmental resistance of the adhesive bond joints. Test environment 1, immersion in deionized water at 23° C., was the chosen test environment for the compressor case coating (see FIG. 19).

Five test samples for each coating system were tested at different test durations in order to evaluate the crack growth length, Δa, and the failure mode of the coating system (i.e. 100% cohesive, 100% primer to adhered, 50% adhesive to primer, etc.). The test sample durations included 1 hour, 4 hours, 8 hours, 24 hours and 168 hours (7 days). After completion of the test duration, the new crack tip location is identified and the crack extension length, Aₐ, is calculated. The samples are then forcibly split open in order to identify the failure mode of the coating system. The crack lengths and failure modes are summarized in Table 2, shown below.

TABLE 2
Wedge Crack Extension Results

| | | Test | | |
|---|---|---|---|---|
| | Coating | Duration | Crack Growth, | |
| Sample ID | System | (hr) | Δa, in. | Failure Mode |
| EPI 1138C-1-1 | OEM | 1 | 0.033 | 100% Adhesive |
| EPI 1138C-1-2 | | 4 | 0.1 | 100% Cohesive |
| EPI 1138C-1-3 | | 8 | 0.3 | 50% Cohesive |
| | | | | 50% Adhesive |
| EPI 1138C-1-4 | | 24 | 1.3 | 100% Adhesive |
| EPI 1138C-1-5 | | 168 | 2.4 | 100% Adhesive |
| EPI 1138C-2-1 | OEM + | 1 | 0 | 100% Cohesive |
| EPI 1138C-2-2 | Primer | 4 | 0.12 | Cohesive, |
| | | | | minor Adhesive |
| EPI 1138C-2-3 | | 8 | 0.005 | 100% Cohesive |
| EPI 1138C-2-4 | | 24 | 0.04 | 100% Cohesive |
| EPI 1138C-2-5 | | 168 | 0 | 100% Cohesive |

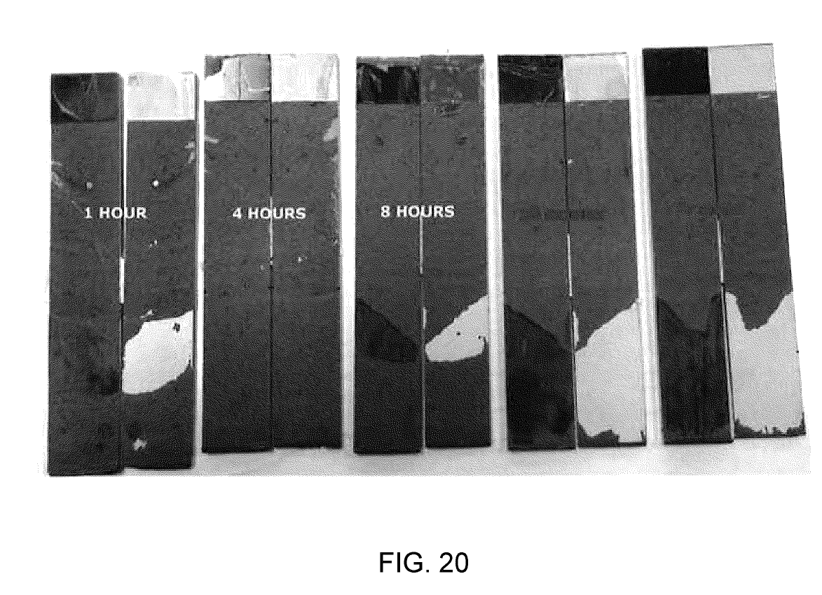

As shown in Table 2, the OEM un-primed coated samples experienced significant crack growth relative to the primed samples as the test duration increased. After 7 days, the crack in the OEM coated sample had propagated the entire length of the coated surface. All of the coated samples were split in order to examine the failure modes and the results of the OEM prepared and coated samples are shown in FIG. 20.

The un-primed samples experienced significant crack growth after 8 hours of exposure and all subsequent test durations. Also, the un-primed samples show that the coating suffered from adhesive coating failure at the coating to base metal interface.

The OEM epoxy coating with the addition of a silane based primer out-performed the OEM coating system in every test. As shown in Table 2, the primed test samples proved to restrict crack growth in all of the test durations. The maximum crack growth length was 0.12″ and the coupon exposed for 7 days did not exhibit any increase in crack length.

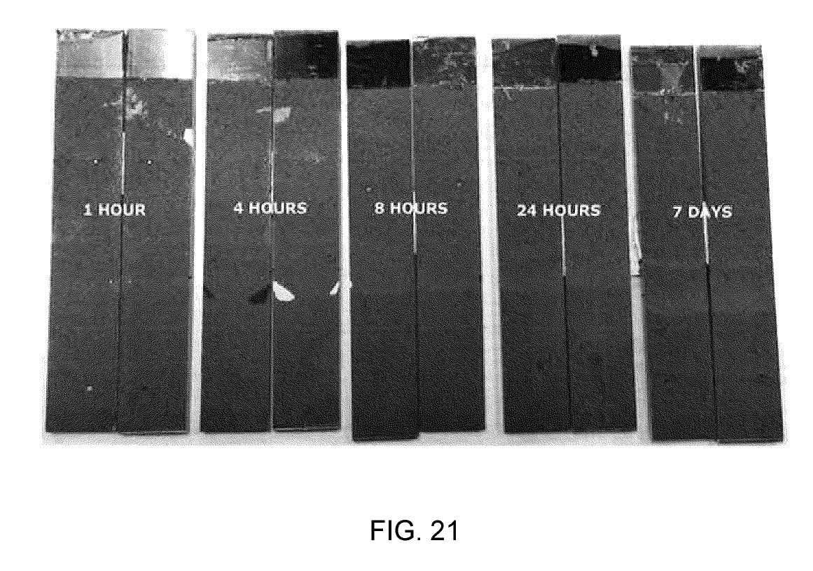

The most significant difference between the primed and un-primed coupons was the failure mode (see FIGS. 20 and 21). All of the primed coupons experienced cohesive failure instead of adhesive failure. Complete cohesive failure compared to adhesive failure with the same epoxy coating being applied proves that the silane based primer greatly improved the environmental resistance of the bond between the base material and the epoxy resin while improving the bond strength.

The wedge test crack results show that the epoxy resin coating with the addition of the silane-based primer will not prevent in-service cracking, but will help reduce major crack propagation and disbond of the case plastic from the substrate. These bond improvements will greatly reduce or eliminate case plastic breakout.

For simplicity and clarity of illustration, where considered appropriate, reference numerals may be repeated among the figures to indicate corresponding or analogous elements. In addition, numerous specific details are set forth in order to provide a thorough understanding of the examples described herein. However, it will be understood by those of ordinary skill in the art that the examples described herein may be practiced without these specific details. In other instances, well-known methods, procedures and components have not been described in detail so as not to obscure the examples described herein. Also, the description is not to be considered as limiting the scope of the examples described herein.

It will be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles.

The steps or operations in the flow charts and diagrams described herein are just for example. There may be many variations to these steps or operations without departing from the principles discussed above. For instance, the steps may be performed in a differing order, or steps may be added, deleted, or modified.

Although the above principles have been described with reference to certain specific examples, various modifications thereof will be apparent to those skilled in the art as outlined in the appended claims.

1. A method of lining a compressor case, the method comprising:
applying a first layer comprising a primer to an interior surface of the compressor case; and
applying at least one second layer over the first layer of primer, the at least one second layer comprising a seal compound to line the compressor case.

2. The method of claim 1, wherein applying the first layer comprises:
grit blasting an area of the interior surface of the compressor case;
spray washing the area of the interior surface;
drying the compressor case;
applying the primer; and
curing the primer.

3. The method of claim 1, wherein the primer is a silane-based primer.

4. The method of claim 2, wherein the primer is applied using a brush, spray, or dip application process.

5. The method of claim 2, wherein the primer is cured using a moisture curing process, or an oven curing process.

6. The method of claim 1, further comprising installing the compressor case in a casting machine prior to applying the at least one second layer to line the compressor case.

7. The method of claim 1, wherein applying the at least one second layer comprises lining the compressor case by:
rotating the case at a first speed;
injecting a first quantity of the seal compound onto the interior surface of the compressor case;
increasing the rotational speed of the case to a second speed that is greater than the first speed;
reducing the rotational speed of the case to a third speed that is less than the second speed; and
injecting an additional quantity of the seal compound onto the interior surface of the compressor case.

8. The method of claim 1, wherein the seal compound comprises an resin-based formulation.

9. The method of claim 8, wherein the resin-based formulation comprises a resin, a talc filler, a resin curing agent, a graphite filler, a silicone dioxide filler, and a catalyst.

10. A lining for a compressor case, the lining comprising:
a layer of primer applied to an interior surface of the compressor case; and
at least one layer of a seal compound applied to the layer of primer.

11. The lining of claim 10, wherein the seal compound comprises an resin-based formulation.

12. The lining of claim 11, wherein the resin-based formulation comprises a resin, a talc filler, a resin curing agent, a graphite filler, a silicone dioxide filler, and a catalyst.
